(19) United States
(12) Patent Application Publication
(10) Pub. No.: US 2025/0373199 A1
(43) Pub. Date: Dec. 4, 2025

(54) PHOTOVOLTAIC ASSEMBLIES WITH CURRENT PROBES

(71) Applicant: SOLARGIK LTD, JERUSALEM (IL)

(72) Inventors: Yossi Azancot, Jerusalem (IL); Greg Ravikovich, Mevaseret Tzion (IL); Gil Kroyzer, Jerusalem (IL); Israel Kroizer, Jerusalem (IL); Morag Am Shallem, Jerusalem (IL)

(21) Appl. No.: 18/731,429

(22) Filed: Jun. 3, 2024

(51) Int. Cl. H02S 40/32; H02S 20/30; H02S 40/36; H02S 50/10

(52) U.S. Cl. CPC H02S 40/32; H02S 20/30; H02S 40/36; H02S 50/10

(57) ABSTRACT

A solar energy system comprises an inverter, an array of PV assemblies, and a set of current-probe assemblies installed in PV assemblies. Each PV assembly comprises a pivotable group of PV panels, a drive system comprising an electric motor and a gearing arrangement, and electronic circuitry comprising a communications arrangement and operative to regulate operation of the electric motor. The PV panels are connected electrically to form a plurality of strings in at least indirect electrical communication with the inverter. At least one string comprises PV panels of different PV assemblies. At least one current-probe assembly is placed in each of the plurality of strings, and each current-probe assembly is operative to measure a direct current value in a respective string.

### FIELD OF THE INVENTION

The present invention relates to solar energy systems and in particular to arrangements for measuring current in PV assemblies and strings of PV panels.

### BACKGROUND

Achieving a diversified low-carbon emissions energy economy has been limited by economic and technological limitations. Solar energy systems comprising photovoltaic (PV) modules are commonly deployed to capture energy from both direct and diffuse (including reflected) solar irradiance. Tracking PV systems are deployed in which PV assemblies are pivoted to reduce optical losses from the direct irradiance component, including the so-called cosine loses wherein the energy absorbed is a function of the cosine of the angle between the incidence vector and a normal vector of the PV assembly.

PV assemblies serve to generate electricity when solar illumination is incident upon the panels. Generated electricity is typically fed into an electrical grid of the city/locality. Large central inverters are often deployed to manage the electrical output of the solar fields and to optimize performance. The optimization is generally performed for large portions of the solar fields, or even for entire solar fields, because of the difficulty in accessing higher-resolution electrical data. Moreover, when safety measures such as detection of electric arc faults are implemented, revenues can be lost when large central inverters ‘trip’, i.e., disconnect, an entire solar field. These issues could be solved if there were available higher-resolution access to electrical data, e.g., voltage and current.

### SUMMARY

According to embodiments of the invention, a solar energy system comprises: (a) an inverter, and (b) an array of PV assemblies, each PV assembly comprising (i) a frame subassembly and a group of PV panels joined thereto and pivotable therewith about a longitudinal axis thereof, (ii) a drive system comprising an electric motor and a gearing arrangement arranged to transfer a torque from the electric motor to the frame subassembly so as to pivot the PV panels, and (iii) electronic circuitry comprising a communications arrangement and operative to regulate operation of the electric motor. The PV panels are connected electrically to form a plurality of strings in at least indirect electrical communication with the inverter, and wherein at least one string comprises PV panels of different PV assemblies The system further comprises (c) a set of current-probe assemblies installed in a respective set of PV assemblies such that at least one current-probe assembly is placed in each of the plurality of strings, each current-probe assembly being operative to measure a direct current value in a respective string and to transmit said value to a computing device.

In some embodiments, at least one PV assembly of the array of PV assemblies can comprise PV panels connected electrically in different strings.

In some embodiments, the PV panels are connected in series to form the plurality of strings.

In some embodiments, it can be that each of the current-probe assemblies can be installed on a support pylon on the respective drive system and electronic circuitry are installed.

In some embodiments, the current measurement can comprise contactless current measurement. In some embodiments, the current-probe assembly can include a computer processor and a Hall-effect sensor.

In some embodiments, the current-probe assembly can include arc-detection circuitry. In some such embodiments, the arc-detection circuitry can be is operative to perform a trip function.

In some embodiments, it can be that at least one of the electronic circuitry of the PV assembly and the computer processor of the current-probe assembly includes stored program instructions for detecting an electric arc based on data received from the current-probe assembly. In some such embodiments, the stored program instructions can include instructions for causing a trip function.

According to embodiments of the invention, a solar energy system comprises (a) an inverter; (b) an array of PV assemblies, each PV assembly comprising a frame subassembly and a group of PV panels joined thereto, wherein the PV panels are connected electrically to form a plurality of strings in at least indirect electrical communication with the inverter, and wherein at least one string comprises PV panels of different PV assemblies; and (c) a set of current-probe assemblies installed in a respective set of PV assemblies such that at least one current-probe assembly is placed in each of the plurality of strings, each current-probe assembly being operative to measure a direct current value in a respective string and to transmit said value to a computing device. In some embodiments, at least one PV assembly of the array of PV assemblies can comprise PV panels connected electrically in different strings. In some embodiments, the PV panels are connected in series to form the plurality of strings. In some embodiments, it can be that each of the current-probe assemblies can be installed on a support pylon on the respective drive system and electronic circuitry are installed. In some embodiments, the current measurement can comprise contactless current measurement. In some embodiments, the current-probe assembly can include a computer processor and a Hall-effect sensor. In some embodiments, the current-probe assembly can include arc-detection circuitry. In some such embodiments, the arc-detection circuitry can be is operative to perform a trip function. In some embodiments, it can be that at least one of the electronic circuitry of the PV assembly and the computer processor of the current-probe assembly includes stored program instructions for detecting an electric arc based on data received from the current-probe assembly. In some such embodiments, the stored program instructions can include instructions for causing a trip function.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a solar energy system, according to embodiments of the present invention.

FIG. 2 shows a schematic layout of selected components of a solar energy system according to embodiments of the present invention.

FIG. 3 shows a block diagram of a drive assembly for a solar energy system, according to embodiments of the present invention.

FIG. 4 shows a block diagram of a drive-system controller for a solar energy system, according to embodiments of the present invention.

FIG. 5 shows a block diagram of a current-probe assembly in communication with a drive assembly, according to embodiments of the present invention.

FIGS. 6A and 6B show exemplary schematic arrangements of components of a drive assembly and a current-probe assembly arranged on a support pylon of a PV assembly, according to embodiments of the present invention.

FIG. 7 is a schematic drawing of an array of PV assemblies wired to a central inverter, according to embodiments of the present invention.

FIG. 8 is a schematic drawing of an array of PV assemblies comprising PV panels wired in different strings, according to embodiments of the present invention.

FIG. 9 shows a block diagram of a current-probe assembly comprising arc-detection circuitry, according to embodiments of the present invention.

FIGS. 10A and 10B show respective block diagrams of exemplary arc-detection circuits.

FIGS. 11A, 11B and 12 show respective schematic diagram of a portion of a PV assembly comprising one or more sensors, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements. Subscripted reference characters (e.g., 10₁ or 10_{A}) may be used to designate multiple separate appearances of elements of a single species, whether in a drawing or not; for example: 10₁ is a single appearance (out of a plurality of appearances) of element 10. The same elements can alternatively be referred to without subscript (e.g., 10 and not 10₁) when not referring to a specific one of the multiple separate appearances, i.e., to the species in general.

The term ‘solar energy system’ as used herein means a system for generating electricity using an array of one or more PV assemblies. The system can include an inverter for converting the direct-current (DC) electricity generated by the PV assemblies to alternating current (AC) electricity, e.g., for delivery to an electricity grid, and/or other electronics, e.g., for optimizing voltage and current of a module or group or modules, e.g., an electrical string of modules.

A ‘solar tracker’, ‘PV tracker’, or simply ‘tracker’, is an arrangement that changes the orientation of the PV panels in response to commands from a controller. The orientation of PV panels in a tracker can change with respect to a single axis or to two axes, or, equivalently, in one plane or in two planes. Whenever direct solar irradiance is available, it is often desirable for the tracker to be oriented and incrementally pivoted to a set of maximum-irradiance orientations so as to capture, i.e., convert, the highest possible proportion of the direct irradiance falling on the panels over the course of a given period of time. In some instances, the tracker is oriented to capture and convert energy up to a given maximum or setpoint. Capture and conversion of the diffuse radiation component of the incident solar irradiance is considerably smaller than that of the direct component in clear-sky conditions, and therefore the tracking is less affected by the distribution of diffuse radiation. Any of the tracker-related terms used herein can also be understood, unless excluded by context, to include the PV assemblies being pivoted.

Unless indicated otherwise, the term ‘PV assembly’ is used interchangeably in this disclosure with ‘tracker’, but this is merely for convenience and any of the embodiments disclosed herein apply as well, mutatis mutandis, to PV assemblies that are not pivotable and that do not track the angle of the sun.

Embodiments of the invention relate to solar energy systems, including, without exclusion, solar energy systems comprising large solar fields and large central inverters, and more specifically to solar energy systems in which arrangements are provided in the PV assemblies for measurement of direct current passing through respective PV strings. The term ‘PV string’ as used herein means a plurality of PV panels wired together, generally in series, to carry photovoltaically generated power to an inverter or to a string ‘combiner’ which combines the output of multiple strings before delivering the output to the inverter. The strings are often connected in parallel at the combiner.

In embodiments, measurement of DC current in a PV string is accomplished by providing a ‘current probe’ in respective PV assemblies. A ‘current probe’, as the term is used herein, means a device or arrangement for measuring current, especially DC current, in a PV string. The term ‘current-probe assembly’ as used herein means an arrangement of components used in measuring current in a PV assembly, i.e., to perform the function of a current probe and optionally to perform additional functions such as, and not exhaustively, communications and arc detection.

In some embodiments, the current probe is configured for non-contact current measurement, i.e., without making electrical contact with the current-carrying wires being ‘probed’. In a non-limiting example, the current is measured by employing a Hall-effect sensor, which can sense a magnetic field generated by the passage of current through a wire and does not require electrical contact with the wire.

In embodiments, the respective PV panels of each PV assembly are wired electrically as respective PV strings that deliver DC power to an inverter or to a PV string combiner that delivers the power of multiple strings to the inverter. In other words, in such embodiments, the individual PV assemblies correspond one-to-one to PV strings and vice versa. An example of a PV assembly is a ‘tracker’ comprising an array of PV panels assembled to rotate together around a longitudinal axis, e.g., a central longitudinal axis. Another example of a PV assembly is an array of PV panels that do not rotate. In some embodiments, a PV string can comprise PV panels of different PV assemblies. For example, a PV string can comprise all of the PV panels of each of multiple PV assemblies, or alternatively can comprise only a portion of the PV panels of one or more respective trackers, and this may or may not be in addition to all of the PV panels of one or more other trackers. In some embodiments, at least one of the PV assembly can comprise PV panels that are wired electrically in different strings, including any combination of complete or partial strings.

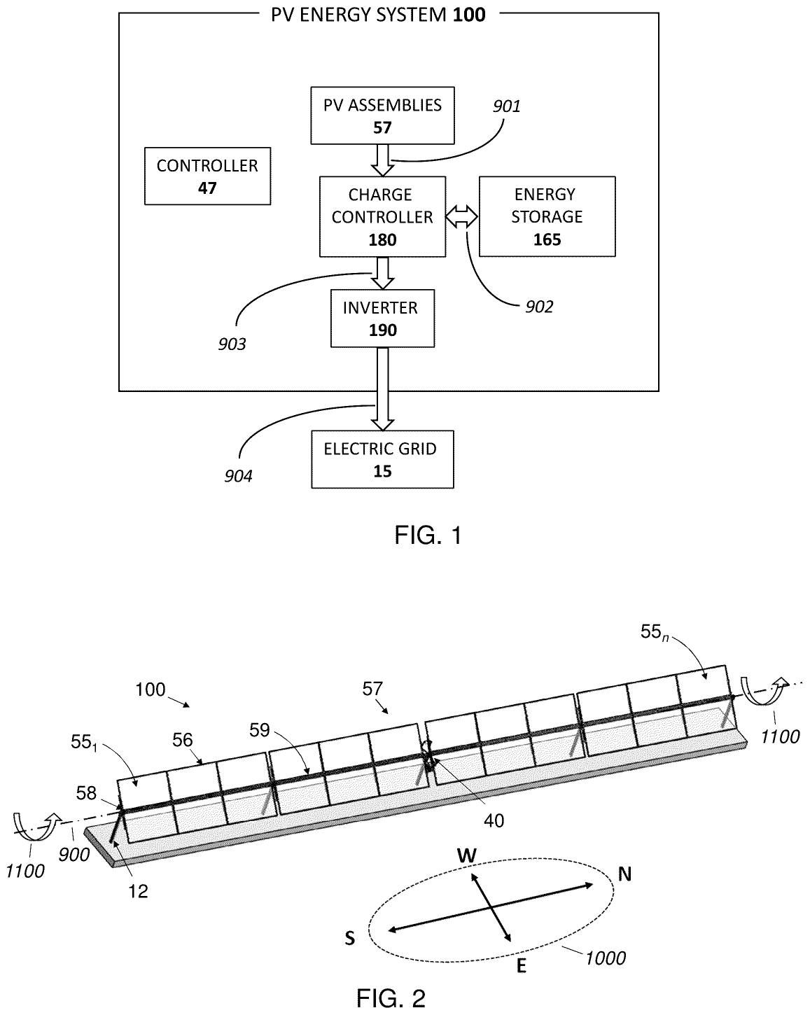

Referring now to the figures, and in particular to FIG. 1, a solar energy system 100 according to embodiments includes one or more PV assemblies 57. In embodiments, the PV assemblies 57 can be of the fixed-plate array variety or can include a tracking component, i.e., a drive system 40, for increasing cumulative electricity generated over the course of a period of time.

The solar system 100 of FIG. 1 additionally includes an inverter 190. An inverter can include electronic circuitry, for example for synchronizing the phase, and for matching the voltage and frequency of the power output to those of the grid. In some embodiments, the solar energy system 100 can include an energy storage device 165 of FIG. 1, which can include a rechargeable battery or capacitor and can be used, e.g., to ‘smooth’ the output of the PV assemblies 57. A charge controller 180 can be provided to mediate between the PV assemblies 57, the inverter 190, and the energy storage device 165, to regulate the charging and discharging processes of the energy storage device 165 and to ensure correct charging and prevent overcharging. A drive-system controller 150 and charge controller 180 are shown schematically for purpose of illustration as separate elements; however, in some embodiments, the control system 47 and charge controller 180 form a single integrated unit. In some embodiments, the charge controller 180 can located in, and/or integrated in, the inverter 190.

FIG. 1 further illustrates a non-limiting example of a power flow scheme for a solar energy system 100: power generated by the PV assemblies 57 flows to the charge controller 180 as indicated by arrow 901. Two-way power flow takes place between the charge controller 180 and the energy storage device 165, as indicated by two-way arrow 902. Power from the PV assemblies 57 and the energy storage device 165 flows through the charge controller 180 to the inverter 190, as indicated by arrow 903. The inverter 190 delivers energy to the electric grid 15, as indicated by arrow 904.

With reference to FIG. 2, an exemplary solar energy system 100 employs single-axis tracking, includes one or more PV assemblies 57. The PV assembly 57 of FIG. 2 includes n PV panels 55₁ through 55ₙ, joined to a support subassembly 58. The support subassembly 58 includes frames 56 for mounting the PV panels 55, and a central elongated member 59 to which the frames 56 are joined. The central elongated member 59 serves to transfer a torque to rotate the frames 56 as a unit together with the central elongated member 59 and the PV panels 55. The PV assembly 57 is rotated about a central longitudinal axis indicated in FIG. 2 by dashed line 900, and the rotation is schematically represented by arrows 400. The PV assembly is rotatable in both directions, although it spends most of the day tracking east-to-west. The central elongated member 59 is pivotably supported by ground supports 12. As shown by axes 1000, the panels are facing generally east, indicating that FIG. 2 shows a morning orientation. The tracking of the PV assembly 57 is shown as being east-west tracking as is the case in the vast majority of current installations of PV assemblies, but the principles disclosed here are equally applicable to north-south tracking systems, mutatis mutandis. A drive system assembly 40 according to embodiments includes a motor assembly and optionally a pivot wheel or other mechanism for transmitting torque, and is also supported by a ground support 12. The drive system 40, as shown in FIG. 2, can be located in the center of the PV assembly 57. In other examples, a drive system 40 can be located elsewhere and/or configured differently than the example illustrated. In some embodiments, the drive system 40 is operable to rotate a pivot wheel positioned to rotate the central elongated member 59 and, with it, the PV assembly 57.

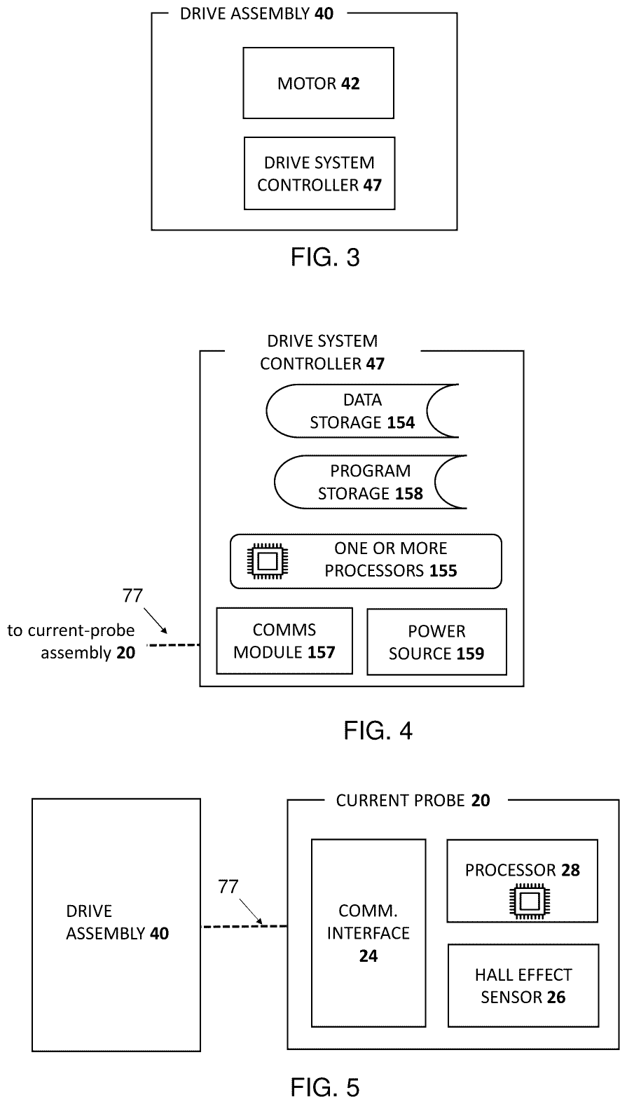

A non-limiting example of a drive assembly 40, (also called a ‘drive controller) for a PV assembly 57 is illustrated schematically in FIG. 3 to show selected components. The drive assembly 40 comprises a motor 42 and a drive-system controller 47 operative to regulate operation of the electric motor 42.

A non-limiting example of a controller 47, (also called a ‘control system’) is illustrated schematically in FIG. 4 to show selected components. The exemplary control system 47 of FIG. 4 includes one or more computer processors 155, a computer-readable storage medium 158, a communications module 157, and a power source 159. The computer-readable storage medium 158 can include transient and/or transient storage, and can include one or more storage units, all in accordance with desired functionality and design choices. The storage 158 can be used for any one or more of: storing program instructions, in firmware and/or software, for execution by the one or more processors 155 of the control system 47. In embodiments, the stored program instructions include program instructions for operating a solar energy system 100 in accordance with any of the embodiments disclosed herein. Data storage 154, if separate from storage 158, can be provided for historical data, e.g., actual irradiance and/or forecast values, e.g., forecasted or projected irradiance values, and other data related to the operation of the solar energy system 100. In some embodiments, the two storage modules 154, 158 form a single module. The communications module 159 is configured to establish communications links, e.g., with a current-probe assembly 20 via communications arrangements 77. The communications module 159 can be operative to maintain communications with an external computer, and/or with various sensors deployed on and/or around the PV assembly 57. In some examples, a control system 47 does not necessarily include all of the components shown in FIG. 4, and in some examples the control system 47 includes additional communications links and/or other components. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as CAN bus (Controller Area Network, Fieldbus, FireWire, HyperTransport and InfiniBand.

FIG. 5 shows a block diagram of an exemplary current-probe assembly 20 according to embodiments, illustrated as being in communication with the drive assembly 40 of the PV assembly 57, e.g., with the communications module 157 of the drive-system controller 47. The exemplary current-probe assembly of FIG. 5 includes a Hall-effect sensor 26 and one or more processors 28 for measuring current, i.e., for measuring the strength of a magnetic field and translating magnetic-field strength to current. The current-probe assembly 20 includes a communications interface, e.g., for communicating current measurements, either to the drive-system controller 47 of the respective PV assembly 57 in which the current-probe assembly 20 is installed, or directly to another computer (not shown). The other computer can be, for example, a processor of an inverter 190, or a central control system of a solar field. In some embodiments, the one or more processors 28 can be part of the drive assembly 40, e.g., as part of the drive-assembly controller 47. In some embodiments, the one or more processors 28 can be the same one or more processors as the one or more processors 155 of the drive-assembly controller 47.

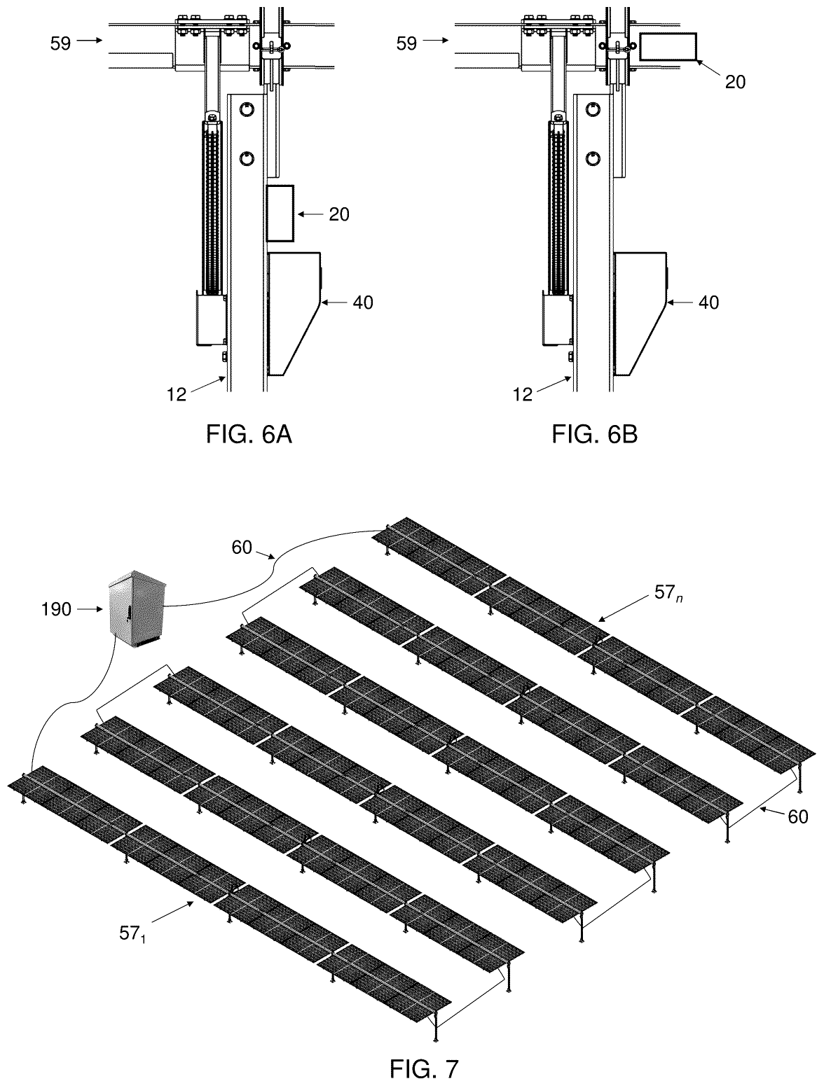

It can be desirable for a current-probe assembly 20 to be deployed in proximity to the drive system 40 of a PV assembly 57, as indicated in the block diagram of FIG. 5. In some embodiments the current-probe assembly 20 and the drive-system controller 47 (along with the motor 42 which is generally deployed together with or in proximity to the drive-system controller 47) are installed in proximity to each other and on the same support pylon 12. FIG. 6A is a schematic illustration of a non-limiting example of the placement of a current-probe assembly 20 on a support pylon 12 of a PV assembly 57. As can be seen, it is the same support pylon bearing the drive system 40 of the PV assembly 57, the drive system comprising a motor 42 and drive-system controller 47 (both located within the enclosure of the drive assembly 40). FIG. 6B is another non-limiting example of the placement of a current- probe assembly 20 on a central elongated member 59 of a PV assembly 57. In some embodiments, the electrical wiring connecting PV panels 55 follows the central elongated member 59 along the length of the PV assembly 57, which makes it convenient for the current-probe assembly 20 to be positioned on the central elongated member 59.

FIG. 7 shows a schematic illustration of an array of n PV assemblies 57 wired directly to an inverter 190 in a single PV string.

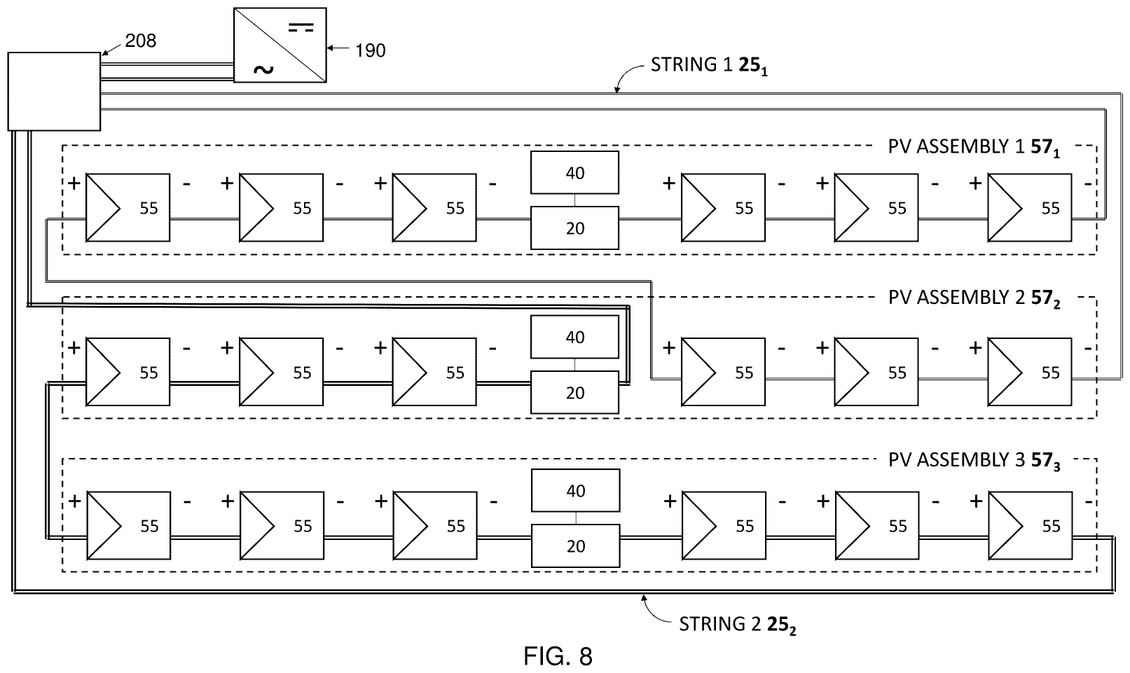

FIG. 8 shows a schematic top-level wiring diagram of an array of 3 PV assemblies 57 comprising respective PV panels 55 that in combination are wired in two PV strings 25. The two strings 25 pass through a string combiner 208 which in turn is connected to a central inverter 190. In some implementations, the string combiner 208 can be wired to additional PV strings (not shown) and there can be additional string combiners (not shown) connected to the inverter 190. The wiring diagram of FIG. 8 is simplified to show selected features, while ignoring, only for the sake of simplicity, other features such as, for example, and not exhaustively: fuses, junction boxes and switches.

In the non-limiting example illustrated in FIG. 8, each of the PV assemblies 57 has a current-probe assembly 20 installed in proximity to the drive assembly 40. A first PV string 25₁ includes all the PV panels 55 of a first PV assembly 57₁, and half of the PV panels 55 of a second PV assembly 57₂. A second PV string 25₂ includes the remaining PV panels 55 of the second PV assembly 57₂, and all the PV panels 55 of a third PV assembly 57₃. In this arrangement, there are two current-probe assemblies 20 in the second PV string 25₂, an artifact of installing a current-probe assembly 20 in every PV assembly 57. One of the two current-probe assemblies 20 can be disabled, or the duplication can be dealt with by software.

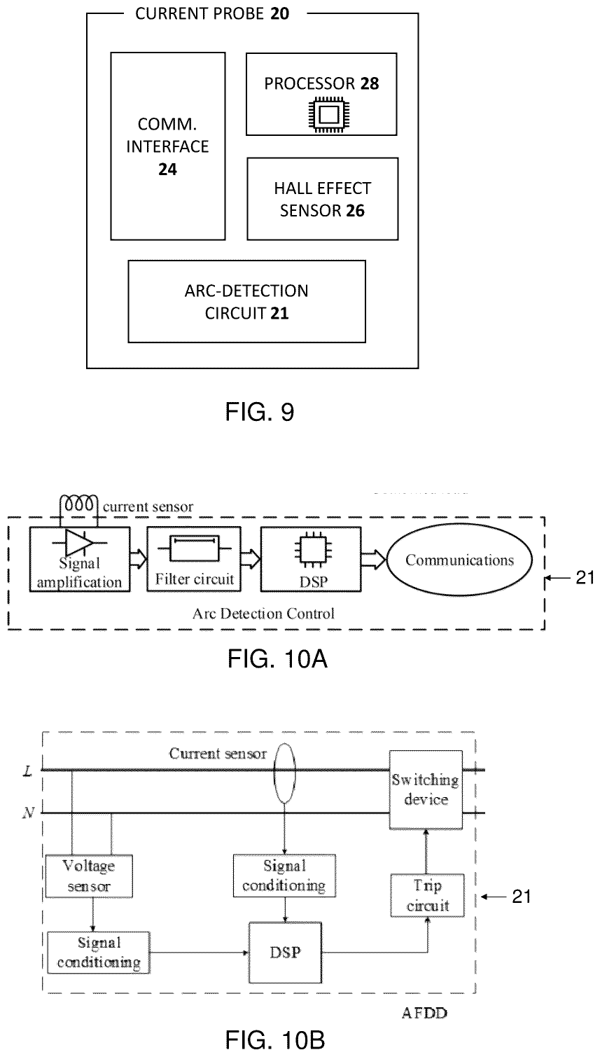

As discussed hereinabove, it can be desirable to detect electric arc faults at a higher resolution rather than at the level of an entire solar field. In embodiments, the presence of the current-probe assembly 20 in PV assemblies 57 provides an opportunity to perform arc detection at the PV string level. Referring now to FIG. 9, a block diagram of a current-probe assembly 20 is shown to include an arc-detection circuit 21. Exemplary top-line diagrams of arc-detection circuits 21 are shown in FIGS. 10A and 10B. The arc-detection circuit 21 of FIG. 10B includes a trip circuit, e.g., a trip circuit that automatically trips the circuit when an electric arc is detected. The functions of the trip circuit can also be performed by software in response to an arc-detection alarm communicated by an arc-detection circuit. Additionally or alternatively, arc detection can be performed using software. Program instructions can be stored in the electronic circuitry of the PV assembly, i.e., in the program storage medium 158 of the drive-system controller 47 in the drive assembly 40, and/or in a storage medium (not shown) in the current-probe assembly 20. In some embodiments, the stored program instructions for detecting an electric arc, e.g., based on data received from the current-probe assembly 20, is carried out by the one or more associated processors 155, 28.

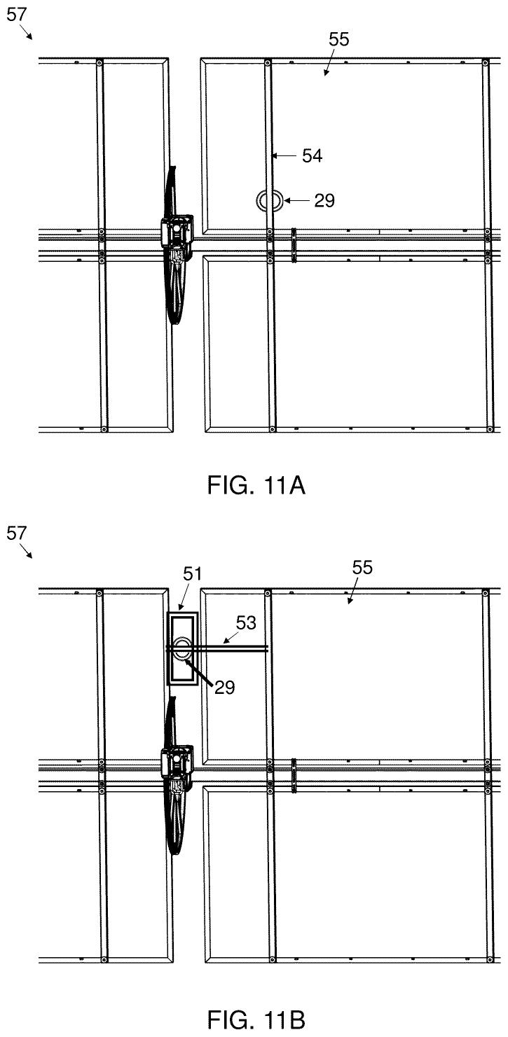

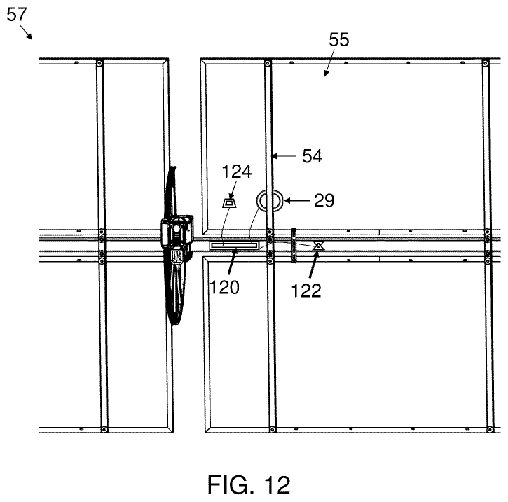

Reference is now made to FIGS. 11A, 11B and 12.

In embodiments, at least one of a processor 155 of the drive-system controller 47 and a processor 28 of a current-probe assembly 20 is in electronic communication with one or more sensors of the PV assembly 57. FIG. 11A includes a schematic illustration of a weighing device 29, e.g., comprising a load cell, in electronic communication (not shown) with one or more processors 155, 28. In the non-limiting example of FIG. 11A, the weighing device 29 is positioned between a PV panel 55 and a backing strut 54 of the frame assembly of the PV assembly 57. In this arrangement, the weighing device 29 is operative to register changes in weight atop the PV panel 55, such as, for example, accumulated snow. The weighing device 29, according to some embodiments, is configured to transmit to the processor(s) 155, 28 weight-related information, and the processor(s) 155, 28 is/are configured (i) to receive the weight-related information over time so as to detect the weight of snow on the PV panel, including a change in the weight of snow, and (ii) if the snow weight or the change in snow weight exceeds a threshold, to rotate the PV panels 55, e.g., to a vertical position, to allow or cause some or all of the snow to drop off the PV panels 55.

FIG. 11B shows an alternative implementation of the weighing device 29. An auxiliary PV panel 51 is provided with a size and output substantially smaller than any of the PV panels 55 of the PV assembly 57, but sized to be sufficient to power the rotation of the PV panels 55 in the absence of external power to the PV assembly 57. In the non-limiting example of FIG. 11B, the weighing device 29 in communication with the processor 155, 28 is disposed between the auxiliary PV panel 51 and a support strut 53. The function of the weighing device 29 and processor 155, 28 is the same as those in the example of FIG. 11A. In some implementations, the installation of the weighing device 29 is easier or more convenient on the auxiliary PV panel 51 than on the main PV panels 55. In some implementations, a small platform (not shown) is used instead of the auxiliary PV panel 51 of FIG. 11B to make the installation of the weighing device 29 easier or more convenient than installing it on one of the main PV panels 55.

FIG. 12A schematically illustrates deployment of a sensor module 120 on the underside a PV panel 55. The sensor module 120 can include, and/or be in electronic communication with, one or more of (and not exhaustively): a temperature sensor 124 operative to measure the temperature of the PV panel 55, an inclinometer 122 operative to measure the angle of inclination of the PV panel 55 and/or of the PV assembly 57 on a single axis (or on two or more axes), and the weighing device 29. Any of the sensors can include analog-to-digital conversion as necessary. Any or all of these sensors can be integrated into the sensor module 120 to form a single unit that can be in electronic communication with a processor 155, 28.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A solar energy system comprising
a. an inverter;
b. an array of PV assemblies, each PV assembly comprising
i. a frame subassembly and a group of PV panels joined thereto and pivotable therewith about a longitudinal axis thereof,
ii. a drive system comprising an electric motor and a gearing arrangement arranged to transfer a torque from the electric motor to the frame subassembly so as to pivot the PV panels, and
iii. electronic circuitry comprising a communications arrangement and operative to regulate operation of the electric motor,
wherein the PV panels are connected electrically to form a plurality of strings in at least indirect electrical communication with the inverter, and wherein at least one string comprises PV panels of different PV assemblies; and
c. a set of current-probe assemblies installed in a respective set of PV assemblies such that at least one current-probe assembly is placed in each of the plurality of strings, each current-probe assembly being operative to measure a direct current value in a respective string and to transmit said value to a computing device.

2. The solar energy system of claim 1, wherein at least one PV assembly of the array of PV assemblies comprises PV panels connected electrically in different strings.

3. The solar energy system of claim 1, wherein the PV panels are connected in series to form the plurality of strings.

4. The solar energy system of claim 1, wherein each of the current-probe assemblies is installed on a support pylon on which the respective drive system and electronic circuitry are installed.

5. The solar energy system of claim 1, wherein the current measurement comprises contactless current measurement.

6. The solar energy system of claim 1, wherein the current-probe assembly includes a computer processor and a Hall-effect sensor.

7. The solar energy system of claim 1, wherein the current-probe assembly includes arc-detection circuitry.

8. The solar energy system of claim 7, wherein the arc-detection circuitry is operative to perform a trip function.

9. The solar energy system of claim 1, wherein at least one of the electronic circuitry of the PV assembly and the computer processor of the current-probe assembly includes stored program instructions for detecting an electric arc based on data received from the current-probe assembly.

10. The solar energy system of claim 9, wherein the stored program instructions include instructions for causing a trip function.

11. A solar energy system comprising
a. an inverter;
b. an array of PV assemblies, each PV assembly comprising a frame subassembly and a group of PV panels joined thereto, wherein the PV panels are connected electrically to form a plurality of strings in at least indirect electrical communication with the inverter, and wherein at least one string comprises PV panels of different PV assemblies; and
c. a set of current-probe assemblies installed in a respective set of PV assemblies such that at least one current-probe assembly is placed in each of the plurality of strings, each current-probe assembly being operative to measure a direct current value in a respective string and to transmit said value to a computing device.
